(19) United States
(12) Patent Application Publication
(10) Pub. No.: US 2025/0346318 A1
(43) Pub. Date: Nov. 13, 2025

(54) PARTS BOX

(71) Applicant: SUZUKI MOTOR CORPORATION, Hamamatsu-shi (JP)

(72) Inventors: Taku SHIOSAKA, Hamamatsu-shi, Shizuoka (JP); Kyoma SUZUKI, Hamamatsu-shi, Shizuoka (JP); Shuichi OIKAWA, Hamamatsu-shi, Shizuoka (JP)

(73) Assignee: SUZUKI MOTOR CORPORATION, Hamamatsu-shi (JP)

(21) Appl. No.: 19/195,872

(22) Filed: May 1, 2025

(30) Foreign Application Priority Data
May 8, 2024 (JP) 2024-076009

(51) Int. Cl. B62J 43/20; B62J 45/00

(52) U.S. Cl. CPC B62J 43/20; B62J 45/00

(57) ABSTRACT

A parts box of a straddle-type vehicle configured to be attached to a seat frame and to store an electrical component on a lateral side of a rear fender, the parts box includes: a parts holder having a storage space opened on an outer side in a vehicle width direction; and a vehicle body cover configured to cover an opening of the storage space from the outer side in the vehicle width direction. An air discharge port continuous with the storage space is formed in an upper wall of the parts holder, and the air discharge port is covered by at least one of the rear fender and the vehicle body cover at a position above the air discharge port.

### CROSS-REFERENCE TO RELATED APPLICATIONS

This application is based on and claims priority under 35 USC 119 from Japanese Patent Application No. 2024-076009 filed on May 8, 2024, the contents of which are incorporated herein by reference.

### TECHNICAL FIELD

The present disclosure relates to a parts box.

### BACKGROUND ART

For example, JP2011-073468A describes a straddle-type vehicle in which a parts box for an electrical component is formed in the vicinity of a rear fender at a rear side of the vehicle. In the straddle-type vehicle, a side edge portion on a left side of a rear fender in a vehicle width direction extends downward, and a support surface for an electrical component is formed on an extending portion of the rear fender. The support surface of the rear fender is covered by a side cover from the left side in the vehicle width direction, and a peripheral wall protrudes from the side cover along an outer edge of the support surface. The peripheral wall contacts the outer edge of the support surface of the rear fender from the side cover, whereby a storage space of the electrical component.

### SUMMARY OF INVENTION

Depending on the type, the electrical component may become at a high temperature due to its heat generation, and it is necessary to release the heat radiated by the electrical component from the storage space of the parts box to the outside. A conceivable configuration is to provide an air discharge port in the parts box, but a foreign matter such as mud may enter the storage space through the air discharge port. When the air discharge port is made small in order to prevent entry of the foreign matter, the heat may be retained in the parts box.

The present disclosure has been made in view of the above circumstances, and an object thereof is to provide a parts box capable of preventing a foreign matter from entering a storage space while improving a cooling performance of an electrical component.

An aspect of the present disclosure provides a parts box of a straddle-type vehicle configured to be attached to a seat frame and to store an electrical component on a lateral side of a rear fender, the parts box including: a parts holder having a storage space opened on an outer side in a vehicle width direction; and a vehicle body cover configured to cover an opening of the storage space from the outer side in the vehicle width direction, in which: an air discharge port continuous with the storage space is formed in an upper wall of the parts holder; and the air discharge port is covered by at least one of the rear fender and the vehicle body cover at a position above the air discharge port.

With the parts box according to an aspect of the present disclosure, the air discharge port is provided above the electrical component, so that hot air warmed by heat generated by the electrical component is discharged to the outside of the parts box through the air discharge port. The air discharge port is covered by the rear fender and/or the vehicle body cover from above, so that a foreign matter such as mud is prevented from entering the storage space from the air discharge port. Since the air is discharged to the outside from the air discharge port, even when a foreign matter enters the inside of the rear fender and/or the vehicle body cover, the foreign matter is less likely to enter the air discharge port due to the air discharge. Accordingly, it is possible to prevent entry of a foreign matter into the storage space while improving the cooling performance of the electrical component.

### BRIEF DESCRIPTION OF DRAWINGS

The present disclosure will be described in detail based on the following without being limited thereto, wherein:

FIG. 1 is a left side view of a straddle-type vehicle according to the present embodiment;

FIG. 2 is a left side view of a parts box according to the present embodiment;

FIG. 3 is a left side view of an inner side of the parts box according to the present embodiment;

FIG. 4 is a perspective view of the inner side of the parts box according to the present embodiment as viewed from a diagonally left front side;

FIG. 5 is a perspective view of the inner side of the parts box according to the present embodiment as viewed from a diagonally left rear side;

FIG. 6 is a perspective view of periphery of an air intake port of the parts box according to the present embodiment;

FIG. 7 is a sectional view of the parts box in FIG. 2 taken along a line A-A;

FIG. 8 is a top view of the parts box according to the present embodiment;

FIG. 9 is a sectional view of the parts box in FIG. 2 taken along a line B-B;

FIG. 10 is a perspective view of the parts box according to the present embodiment; and

FIG. 11 is a perspective view of the parts box and a seat frame according to the present embodiment.

### DESCRIPTION OF EMBODIMENTS

A parts box according to an aspect of the present disclosure is configured to be attached to a seat frame and to store an electrical component on a lateral side of a rear fender. In the parts box, a parts holder is covered with a vehicle body cover, a storage space of the parts holder is opened on an outer side in a vehicle width direction, and the opening of the storage space is covered by the vehicle body cover from the outer side in the vehicle width direction. An air discharge port continuous with the storage space is formed in an upper wall of the parts holder, so that hot air warmed by heat generated by the electrical component is discharged to the outside of the parts box through the air discharge port. The air discharge port is covered by at least one of the rear fender and the vehicle body cover at a position above the air discharge port, so that a foreign matter such as mud is prevented from entering the storage space from the air discharge port. Since the air is discharged to the outside from the air discharge port, even when a foreign matter enters the inside of the rear fender and/or the vehicle body cover, the foreign matter is less likely to enter the air discharge port due to the air discharge. Accordingly, it is possible to prevent entry of a foreign matter into the storage space while improving the cooling performance of the electrical component.

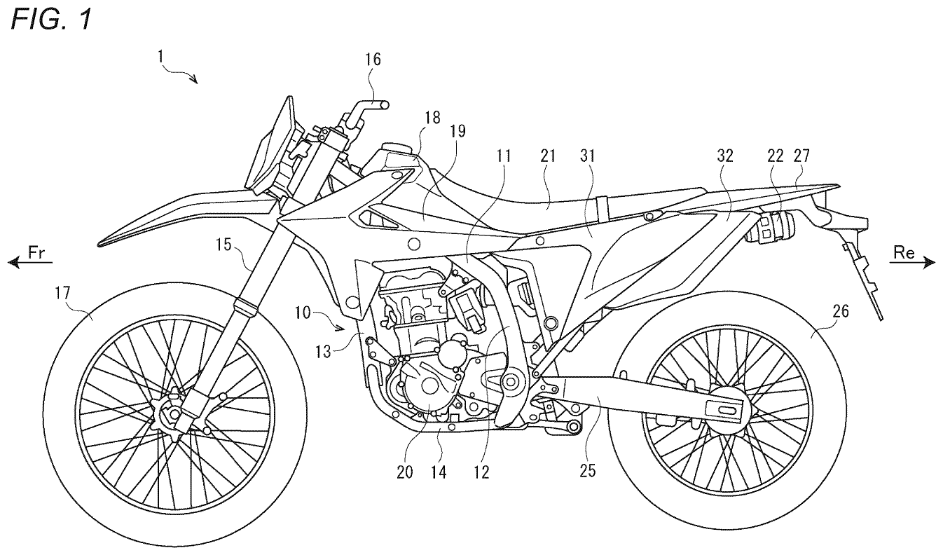

Hereinafter, a straddle-type vehicle including a parts box according to the present embodiment will be described with reference to the accompanying drawings. FIG. 1 is a left side view of the straddle-type vehicle according to the present embodiment. In the following drawings, an arrow Fr indicates a vehicle front side, an arrow Re indicates a vehicle rear side, an arrow L indicates a vehicle left side, and an arrow R indicates a vehicle right side.

As illustrated in FIG. 1, a straddle-type vehicle 1 is implemented by mounting various components such as an engine 20 and an electrical system on a vehicle body frame 10. A pair of main frames 11 extend diagonally rearward and downward from a head pipe (not illustrated) of the vehicle body frame 10. Rear portions of the pair of main frames 11 form a pair of body frames 12 bent downward. A down frame 13 extends downward from the head pipe, and an under loop 14 bent rearward is connected to a lower portion of the down frame 13. Rear ends of the pair of under loops 14 are connected to lower portions of the pair of body frames 12, so that the vehicle body frame 10 is formed into a cradle shape.

A front fork 15 is supported so as to be steered by the head pipe via a steering shaft (not illustrated). A handlebar 16 is provided on an upper portion of the front fork 15. A front wheel 17 is rotatably supported on a lower portion of the front fork 15. Upper portions of the pair of main frames 11 are covered with a fuel tank 18, and the main frames 11 and the fuel tank 18 are covered by a side cover 19 from a lateral side. A seat 21 is installed on the rear side of the fuel tank 18, and a frame cover (vehicle body cover) 31 and a parts cover (vehicle body cover) 32 are installed below the seat 21.

A canister 22 is exposed to the rear of the parts cover 32, and fuel vapor generated in the fuel tank 18 is adsorbed by the canister 22 and sent to the engine 20. The engine 20 is a four-stroke, single-cylinder engine, and is suspended inside the vehicle body frame 10 via a suspension bracket. A swing arm 25 is pivotally supported by the body frames 12. The swing arm 25 extends rearward from the body frame 12, and a rear wheel 26 is rotatably supported at a rear end of the swing arm 25. Power from the engine 20 is transmitted to the rear wheel 26 via a transmission mechanism (not illustrated).

A parts box for storing a battery and various electrical components is installed at a rear portion of the straddle-type vehicle. For example, when a heat-generating electrical component such as a rectifier is stored, it is necessary to provide an air intake port or an air discharge port for the driving wind in the parts box to discharge hot air. When the air intake port and the air discharge port are extremely wide, a foreign matter such as mud that is raised up by the rear wheel enters the parts box and adheres to the rectifier, and the heat dissipation property is reduced. When the air intake port and the air discharge port are extremely narrow, hot air is retained in the parts box. Therefore, in the parts box according to the present embodiment, a path through which a foreign matter enters the air intake port and the air discharge port is complicated while widening the air intake port and the air discharge port.

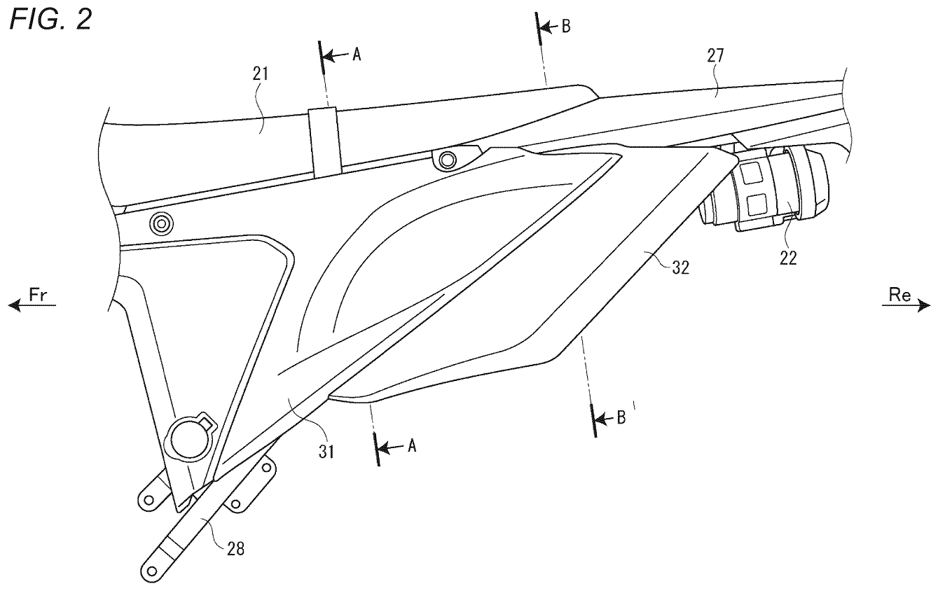

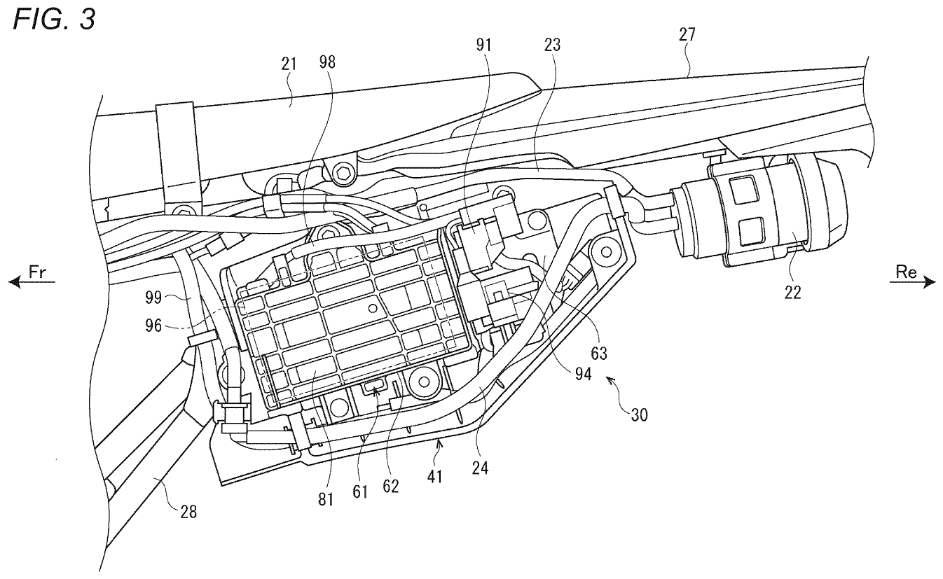

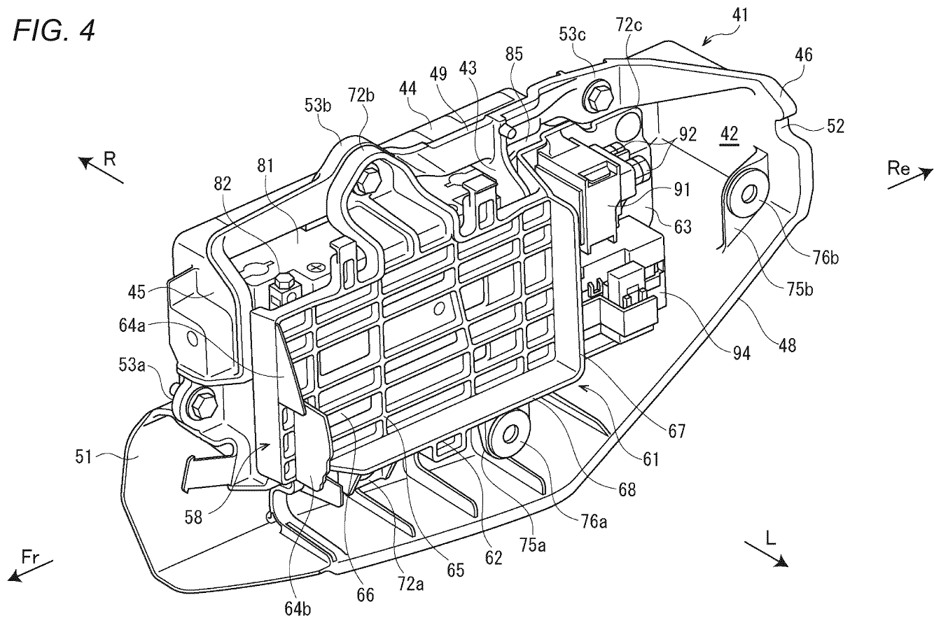

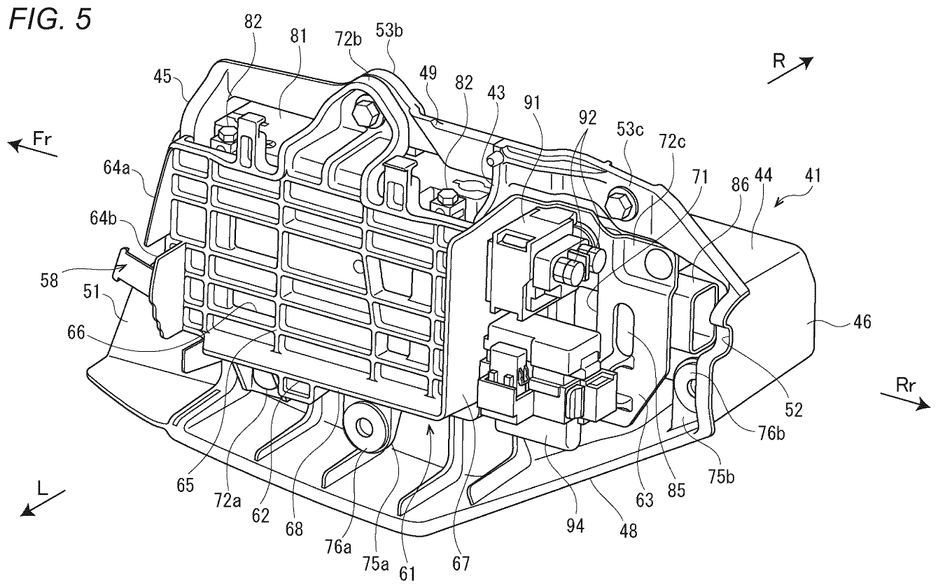

The parts box will be described with reference to FIGS. 2 to 5. FIG. 2 is a left side view of the parts box according to the present embodiment. FIG. 3 is a left side view of an inner side of the parts box according to the present embodiment. FIG. 4 is a perspective view of the inner side of the parts box according to the present embodiment as viewed from a diagonally left front side. FIG. 5 is a perspective view of the inner side of the parts box according to the present embodiment as viewed from a diagonally left rear side.

As illustrated in FIG. 2, a rear fender 27 is installed on the rear side of the seat 21, and an upper surface of a rear portion of the vehicle is formed by the seat 21 and the rear fender 27. The frame cover 31 and the parts cover 32 are installed below the seat 21 and the rear fender 27, and an outer side surface of the rear portion of the vehicle is formed by the frame cover 31 and the parts cover 32. A seat frame 28 at a rear side of the body frame 12 is covered by the frame cover 31 from the outer side in the vehicle width direction. The parts cover 32 is continuous to a rear edge of the frame cover 31. The canister 22 is supported below the rear fender 27 and on the rear side of the parts cover 32.

As illustrated in FIG. 3, the parts box 30 has a slim shape with a small left-right dimension, and is attached to a left side portion of the seat frame 28 above the rear wheel 26 (see FIG. 1). A battery 81, a plurality of electrical components, and the like are stored in the parts box 30 on a lateral side of the rear fender 27. An inner side surface (one side surface on inner side in vehicle width direction) of the parts box 30 is formed by a parts holder 41, and an outer side surface (other side surface on outer side in vehicle width direction) of the parts box 30 is formed by the frame cover 31 and the parts cover 32 (see FIG. 2). A storage space 42 (see FIG. 4) opened on the outer side in the vehicle width direction is formed in the parts holder 41. The opening of the storage space 42 is covered by the frame cover 31 and the parts cover 32 from the outer side in the vehicle width direction.

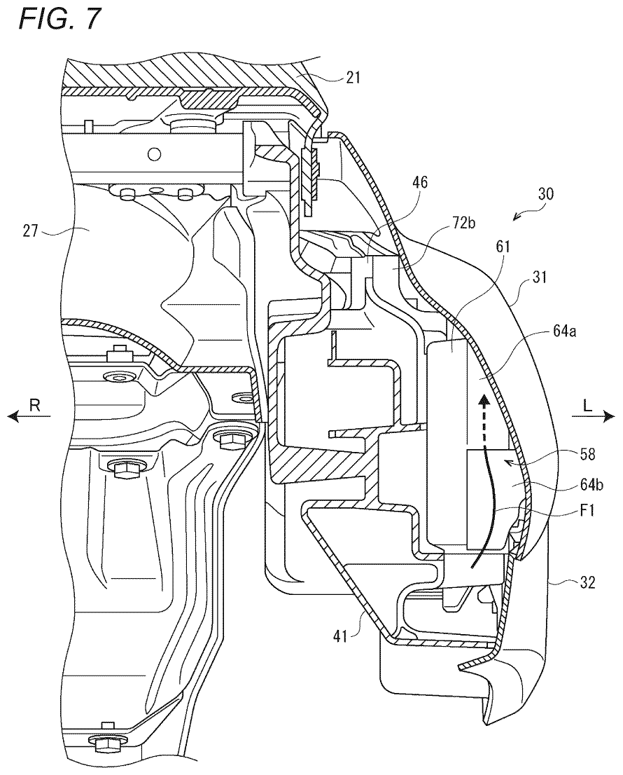

The storage space 42 of the parts box 30 is partitioned into an inner side and an outer side in the vehicle width direction by a separator (battery cover) 61. A front portion of the separator 61 is a battery holding portion 62, and a rear portion of the separator 61 is a parts holding portion 63. The battery 81 is held on an inner side surface of the battery holding portion 62, and a rectifier 85 (see FIG. 7), a starter motor relay 91, and a fuse box 94 are held as the plurality of electrical components on both side surfaces of the parts holding portion 63. A maintenance note (note) 96, lead wires 98, a main harness 99, a purge hose 24, and the like are stored in the storage space 42 of the parts box 30.

As illustrated in FIGS. 4 and 5, the parts holder 41 is formed in a box shape opened to the outer side (left side) in the vehicle width direction. The battery 81 having a rectangular shape in a side view is stored in a front half of an upper portion of the parts holder 41, and an inner side of the parts holder 41 is partitioned by a partition wall 43 to form a storage chamber for the battery 81. The plurality of electrical components are stored in a rear half of the upper portion of the parts holder 41, and a wiring route such as a cable, a hose, or the like is secured in a lower portion of the parts holder 41. An upper wall 44 of the parts holder 41 is further retracted to the inner side in the vehicle width direction, and a wiring route such as a cable or the like is also secured at the outer side in the vehicle width direction of a wall portion 49 protruding upward from a left side edge of the upper wall 44.

A lower side of a front wall 45 of the parts holder 41 is opened, and cables are routed inside the parts holder 41 through an opening 51 of the front wall 45. A rear wall 46 of the parts holder 41 is partially cut out, and the purge hose 24 (see FIG. 3) of the canister 22 extends to the outer side of the parts holder 41 through a notch 52 of the rear wall 46. The surge hose 23 (see FIG. 3) of the canister 22 extends rearward above the parts holder 41. A fixing portion 53a is provided on the front wall 45 of the parts holder 41, fixing portions 53b and 53c are provided on the wall portion 49 of the upper wall 44 of the parts holder 41, and the parts holder 41 is screwed to the seat frame 28 by the three fixing portions 53a to 53c.

The separator 61 is fixed to the parts holder 41, and the inner side of the parts holder 41 is partitioned by the separator 61 in the vehicle width direction. The separator 61 is formed by connecting the battery holding portion 62 and the parts holding portion 63 in a crank shape in a top view. More specifically, the parts holding portion 63 is located on the rear side of the battery holding portion 62, and the parts holding portion 63 is located inward (battery 81 side) in the vehicle width direction with respect to the battery holding portion 62. Since the parts holding portion 63 is offset inward in the vehicle width direction with respect to the battery holding portion 62, the plurality of electrical components are compactly stored in a rear space of the battery 81 which is wide.

The battery holding portion 62 is formed in a rectangular shape in a side view, and the battery 81 is covered from the outer side in the vehicle width direction by the battery holding portion 62. The battery 81 is held on an inner side surface of the battery holding portion 62. A pair of battery terminals 82 are provided on an upper portion of the battery 81, and the pair of battery terminals 82 are exposed from between the upper wall 44 of the parts holder 41 and the battery holding portion 62. One battery terminal 82 is located on an upper front side of the battery 81, and the other battery terminal 82 is located on an upper rear side of the battery 81. A pair of lead wires 98 (see FIG. 3) are connected to the pair of battery terminals 82.

A pair of partition plates 64a and 64b protrude outward in the vehicle width direction from a front edge of the battery holding portion 62. The partition plate 64a is located at an upper half of the front edge of the battery holding portion 62 and extends in an upper-lower direction, and the partition plate 64b is located at a lower half of the front edge of the battery holding portion 62 and extends in the upper-lower direction. The partition plate 64b is located on the rear side of the partition plate 64a with a gap therebetween, and the partition plates 64a and 64b form a labyrinth structure that allows a driving wind to pass therethrough and prevents entry of a foreign matter such as mud. A grid-like rib 65 is formed on an outer side surface of the battery holding portion 62, and an opening 66 for exposing the battery 81 is formed between a part of the rib 65.

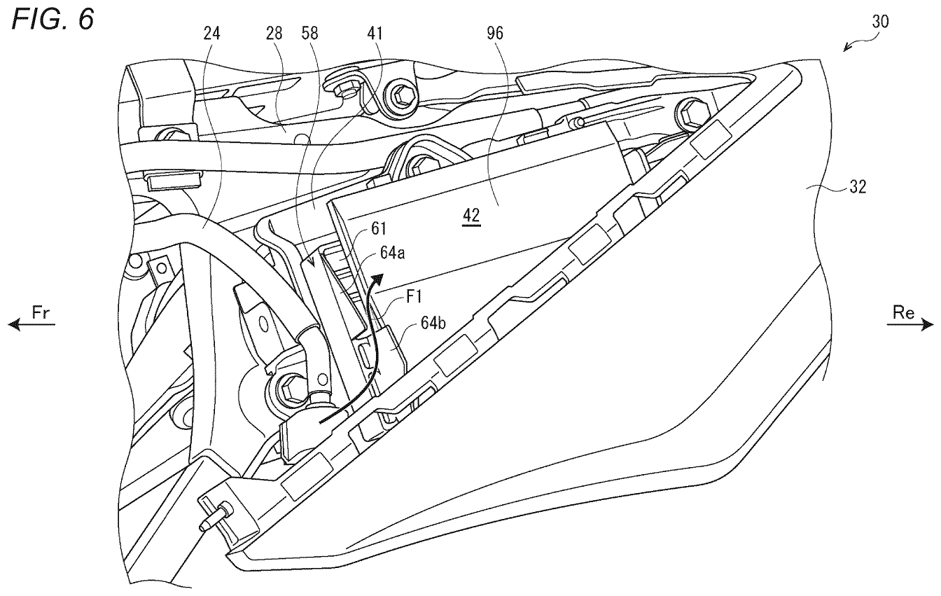

A rear plate 67 protrudes outward in the vehicle width direction from a rear edge of the battery holding portion 62, and a lower plate 68 protrudes outward in the vehicle width direction from a lower edge of the battery holding portion 62. A storage chamber for the maintenance note 96 (see FIG. 6) is formed on the outer side in the vehicle width direction of the battery holding portion 62 by the pair of partition plates 64a and 64b, the rear plate 67, and the lower plate 68. The rectifier 85 is held in a vertical orientation on an inner side surface of the parts holding portion 63. A connector 86 of the rectifier 85 is directed rearward, and the main harness 99 (see FIG. 3) continuous to an electrical component or the like of the vehicle body is connected to the connector 86.

The starter motor relay 91 and the fuse box 94 are vertically aligned and held on the outer side surface of the parts holding portion 63. The starter motor relay 91 is located at the upper side, and the fuse box 94 is located at the lower side. A pair of relay terminals 92 of the starter motor relay 91 are directed rearward, and the lead wires 98 extending from the pair of battery terminals 82 are connected to the pair of relay terminals 92. A pair of elongate holes 71 for exposing the rectifier 85 is formed in the center of the parts holding portion 63. In this manner, the rectifier 85, the starter motor relay 91, and the fuse box 94 are compactly held by the parts holding portion 63.

A fixing portion 72a protrudes downward from the lower edge of the battery holding portion 62, and a fixing portion 72b extends inward in the vehicle width direction from an upper edge of the battery holding portion 62 through between the pair of battery terminals 82. A fixing portion 72c is provided at an upper rear side of the parts holding portion 63. The battery holding portion 62 and the parts holding portion 63 are screwed to the parts holder 41 by the fixing portions 72a and 72c, and the battery holding portion 62 and the parts holder 41 are screwed to the seat frame 28 by the fixing portion 72b. In this manner, the separator 61 is fixed to the parts holder 41 at two positions in the upper-lower direction of the battery 81 and one position on the rear side of the starter motor relay 91.

On the rear side of the fixing portion 72a of the battery holding portion 62, a fixing portion 75a protrudes downward from the lower edge of the battery holding portion 62, and a rubber bush 76a is mounted on the fixing portion 75a. A fixing portion 75b protrudes inward from a corner portion between the rear wall 46 and a lower wall 48 of the parts holder 41, and a rubber bush 76b is mounted on the fixing portion 75b. The parts cover 32 is inserted and fixed to the fixing portions 75a and 75b. In this manner, the parts cover 32 is fixed to the separator 61 (battery holding portion 62) at one position below the maintenance note 96, and the parts cover 32 is fixed to the parts holder 41 at one position on the rear side of the fuse box 94.

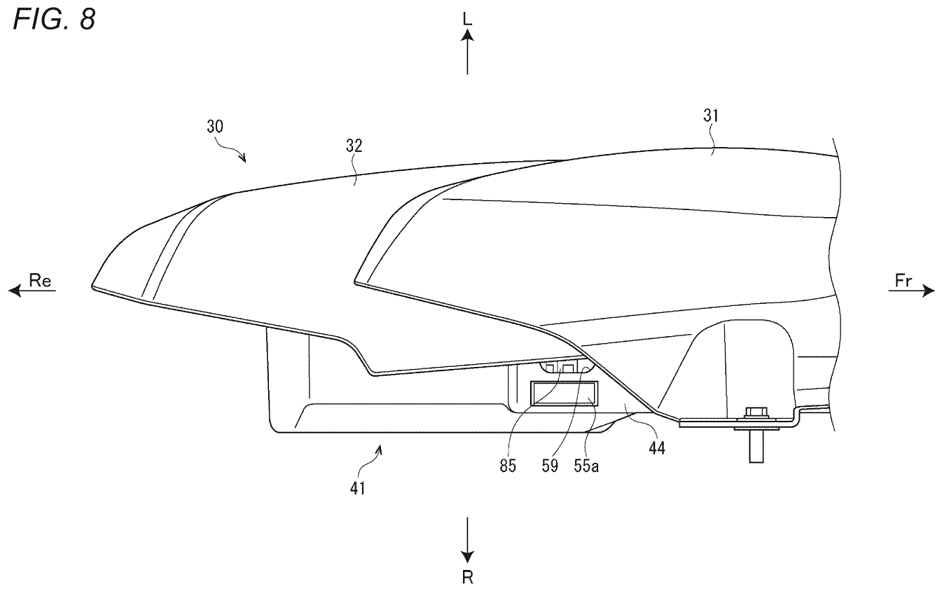

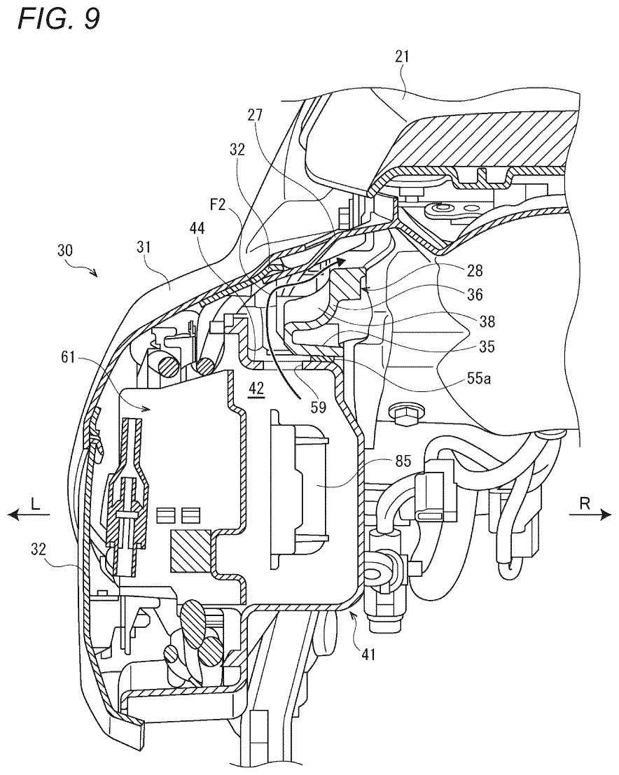

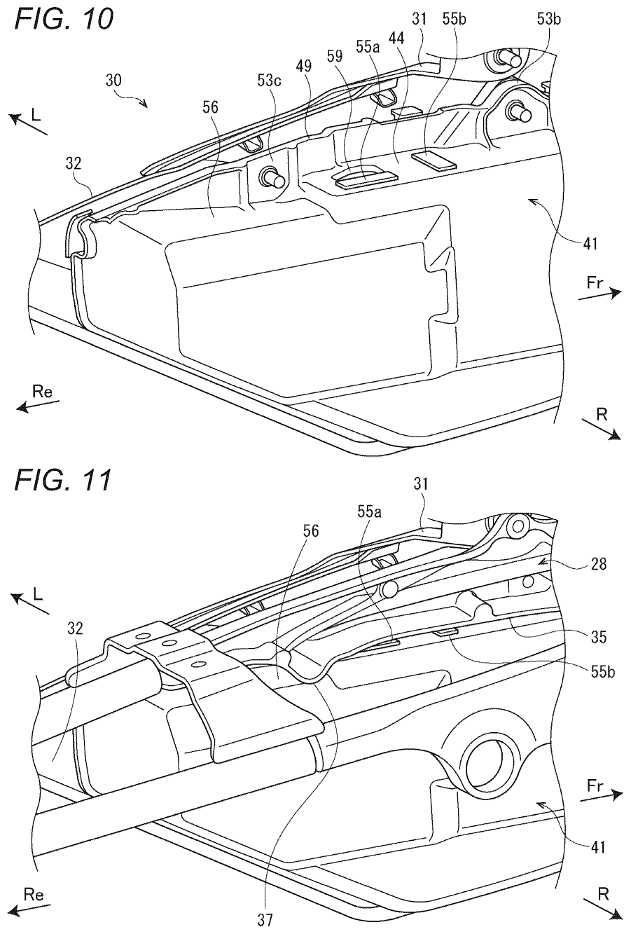

Structures in the vicinity of the air intake port and the air discharge port of the parts holder will be described with reference to FIGS. 6 to 10. FIG. 6 is a perspective view of periphery of the air intake port of the parts box according to the present embodiment. FIG. 7 is a sectional view of the parts box in FIG. 2 taken along a line A-A. FIG. 8 is a top view of the parts box according to the present embodiment. FIG. 9 is a sectional view of the parts box in FIG. 2 taken along a line B-B. FIG. 10 is a perspective view of the parts box according to the present embodiment. FIG. 11 is a perspective view of the parts box and the seat frame according to the present embodiment. FIG. 6 illustrates a state where a frame cover is removed.

As illustrated in FIGS. 6 and 7, in a front portion of the parts box 30, an air intake port 58 for taking the driving wind into the storage space 42 is formed by the separator 61 and the frame cover 31. By combining the separator 61 and the frame cover 31, the degree of freedom of the shape of the air intake port 58 is increased. In the present embodiment, as described above, the pair of partition plates 64a and 64b protrude outward in the vehicle width direction from a front edge of the separator 61 to form an inner surface of the frame cover 31. One partition plate 64a is located at the upper side of the separator 61, the other partition plate 64b is located at the lower side of the separator 61, and the partition plate 64b at the lower side is located on the rear side of the partition plate 64a at the upper side.

As indicated by an arrow F1, in the front portion of the parts box 30, the driving wind is guided from the lower side to the upper side along the partition plate 64b at the lower side, and the driving wind is taken into the storage space 42 from the gap between the pair of partition plates 64a and 64b. In this case, a labyrinth structure is formed in the air intake port 58 that the pair of partition plates 64a and 64b are spaced apart from each other in the upper-lower direction and the front-rear direction and the gap therebetween is not visible from the front, so that a foreign matter is less likely to enter the air intake port 58 due to the labyrinth structure. In this manner, entry of a foreign matter into the storage space 42 from the air intake port 58 is prevented, and hot air warmed by the heat generated by the rectifier 85 is pushed out by the driving wind taken in from the air intake port 58.

As illustrated in FIGS. 8 and 9, in a central portion of the parts box 30, an air discharge port 59 continuous with the storage space 42 is formed in the upper wall 44 of the parts holder 41. The air discharge port 59 is located directly above the rectifier 85 in the top view. The air discharge port 59 is covered by the rear fender 27, the frame cover 31, and the parts cover 32 at a position above the air discharge port 59, that is, at a position separated upward from the air discharge port 59. The seat frame 28 is located below the rear fender 27 and above the air discharge port 59, and the seat frame 28 overlaps with a part of the air discharge port 59 on the inner side in the vehicle width direction in the top view.

The seat frame 28 enters the inner side in the vehicle width direction upward from the air discharge port 59 in the sectional view. More specifically, a bottom surface portion 35 of the seat frame 28 faces the upper wall 44 of the parts holder 41, and a side surface portion 36 of the seat frame 28 is curved upward and inward in the vehicle width direction. On the upper wall 44 of the parts holder 41, cushion sheets 55a and 55b (see FIG. 10 for cushion sheet 55b) are installed on the front side and on a lateral side of the air discharge port 59, respectively. Although the bottom surface portion 35 of the seat frame 28 is spaced apart from the air discharge port 59 by at least thicknesses of the cushion sheets 55a and 55b, there is almost no gap between the bottom surface portion 35 of the seat frame 28 and the air discharge port 59.

As indicated by an arrow F2, in the upper portion of the parts box 30, hot air warmed by heat generated by the rectifier 85 is discharged from the air discharge port 59 together with driving wind. The driving wind flows upward along the side surface portion 36 of the seat frame 28, passes between the seat frame 28 and the frame cover 31, and is discharged, together with the hot air, toward the inside of the rear fender 27. In this manner, the hot air is easily released through the air discharge port 59 to the inner side in the vehicle width direction due to a sectional shape of the seat frame 28. In particular, since the air discharge port 59 is located directly above the rectifier 85 which is a heat generating component, the hot air around the rectifier 85 is effectively discharged.

In this case, the air discharge port 59 is entirely covered by the rear fender 27, the frame cover 31, and the parts cover 32. Further, a substantially half of the air discharge port 59 on the inner side in the vehicle width direction is partially covered by the seat frame 28. Even when a foreign matter is wound up by the rear wheel 26 (see FIG. 1), the foreign matter is less likely to enter the air discharge port 59 from above. Since the hot air is discharged together with the driving wind from the air discharge port 59, even when a foreign matter enters the inside of the rear fender 27, the foreign matter is less likely to enter the air discharge port 59 due to blowing of the driving wind or the like. In this manner, entry of a foreign matter into the storage space 42 from the air discharge port 59 is prevented, and hot air warmed by the heat generated by the rectifier 85 (see FIG. 9) is discharged from the air discharge port 59.

As illustrated in FIG. 10, the wall portion 49 is provided on the left side edge of the upper wall 44 of the parts holder 41. The wall portion 49 is located at the outer side in the vehicle width direction with respect to the air discharge port 59, and the wall portion 49 extends in the front-rear direction so as to partition a space above the parts holder 41 into left and right spaces. Since the wall portion 49 is provided at the outer side in the vehicle width direction with respect to the air discharge port 59, a foreign matter is less likely to enter the air discharge port 59 from the outer side in the vehicle width direction. As described above, the cushion sheets 55a and 55b are provided on the front side and on the lateral side of the air discharge port 59, respectively. Since the gap between the cushion sheets 55a and 55b and the seat frame 28 (see FIG. 11) is also narrowed, a foreign matter is less likely to enter the air discharge port 59 from the inner side in the vehicle width direction and the front side.

As illustrated in FIGS. 10 and 11, the parts holder 41 is fixed to the seat frame 28 by the fixing portions 53b and 53c on the wall portion 49. The side surface portion 36 of the seat frame 28 is provided with a pair of boss portions 38 (see FIG. 9, only boss portion 38 on front side is illustrated) corresponding to the fixing portions 53b and 53c, and the pair of boss portions 38 of the seat frame 28 are fixed to the fixing portions 53b and 53c of the parts holder 41. Fixing positions of the parts holder 41 and the seat frame 28 are provided on the front side and on the rear side of the air discharge port 59, respectively, and the front and rear fixing portions serve as barriers so that a foreign matter is less likely to enter the air discharge port 59 from the front and rear.

An upper surface of the parts holder 41 is further lowered on the rear side of the air discharge port 59, and a protruding portion 37 protrudes downward from the bottom surface portion 35 of the seat frame 28 so as to enter a lowered lower step portion 56 of the parts holder 41. Since the protruding portion 37 of the seat frame 28 enters the lower step portion 56 of the parts holder 41, a foreign matter is less likely to enter the air discharge port 59 from the rear due to the protruding portion 37 of the seat frame 28. In this manner, in the parts box 30 according to the present embodiment, not only entry of a foreign matter into the air discharge port 59 from above is prevented, but also entry of a foreign matter into the air discharge port 59 from the front, the rear, the outer side in the vehicle width direction, and the inner side in the vehicle width direction is prevented.

As described above, with the parts box 30 according to the present embodiment, the air discharge port 59 is provided above the rectifier 85, so that the hot air warmed by the heat generated by the rectifier 85 is discharged to outside of the parts box 30 through the air discharge port 59. By covering the air discharge port 59 from the periphery, it is possible to prevent a foreign matter such as mud from entering the storage space 42 from the air discharge port 59. Since the air is discharged to the outside from the air discharge port 59, even when a foreign matter enters the inside of the rear fender 27 or the like, the foreign matter is less likely to enter the air discharge port 59 due to the air discharge. Accordingly, it is possible to prevent entry of a foreign matter into the storage space 42 while improving the cooling performance of the rectifier 85.

Although the present embodiment shows an example in which the electrical component is a rectifier, the type of the electrical component is not particularly limited as long as the electrical component generates heat.

In the present embodiment, the vehicle body cover is implemented by the frame cover and the parts cover, but the vehicle body cover may be implemented by a single member or may be implemented by three or more members.

In the present embodiment, the air discharge port is covered by the frame cover, the parts cover, and the rear fender, but the air discharge port may be covered by at least one of the frame cover, the parts cover, and the rear fender.

In the present embodiment, the air discharge port is formed directly above the rectifier, but the air discharge port may be formed at a position deviated from directly above the rectifier as long as the air discharge port is formed in the upper wall of the parts holder.

In the present embodiment, the seat frame overlaps with the substantially half of the air discharge port on the inner side in the vehicle width direction in the top view, but the seat frame may partially overlap with the air discharge port in the top view.

In the present embodiment, the partition plate at the lower half of the separator is located on the rear side of the partition plate at the upper half of the separator, but the pair of partition plates may be spaced apart from each other in the front-rear direction to form a labyrinth structure at the air intake port. For example, the partition plate at the lower half of the separator may be located on the front side of the partition plate at the upper half of the separator.

The parts box according to the present embodiment is not limited to the above-described straddle-type vehicle and may be adopted in other straddle-type vehicles. The straddle-type vehicle is not limited to a general vehicle in which a driver rides on a seat in a posture of straddling the seat, and includes a scooter-type vehicle in which the driver rides on the seat without straddling the seat.

As described above, in a first aspect, there is provided a parts box (30) of a straddle-type vehicle (1) configured to be attached to a seat frame (28) and to store an electrical component (rectifier 85) on a lateral side of a rear fender (27), the parts box (30) including: a parts holder (41) having a storage space (42) opened on an outer side in a vehicle width direction; and a vehicle body cover (frame cover 31, parts cover 32) configured to cover an opening of the storage space from the outer side in the vehicle width direction, in which: an air discharge port (59) continuous with the storage space is formed in an upper wall (44) of the parts holder, and the air discharge port is covered by at least one of the rear fender and the vehicle body cover at a position above the air discharge port. With this configuration, the air discharge port is provided above the electrical component, so that hot air warmed by heat generated by the electrical component is discharged to the outside of the parts box through the air discharge port. The air discharge port is covered by the rear fender and/or the vehicle body cover from above, so that a foreign matter such as mud is prevented from entering the storage space from the air discharge port. Since the air is discharged to the outside from the air discharge port, even when a foreign matter enters the inside of the rear fender and/or the vehicle body cover, the foreign matter is less likely to enter the air discharge port due to the air discharge. Accordingly, it is possible to prevent entry of a foreign matter into the storage space while improving the cooling performance of the electrical component.

In a second aspect, there is provided the parts box according to the first aspect, in which the seat frame is located at a position above the air discharge port. With this configuration, the air discharge port is covered by the seat frame, so that a foreign matter is less likely to enter the air discharge port from above.

In a third aspect, there is provided the parts box according to the second aspect, in which: in a top view, the seat frame overlaps with a part of the air discharge port on an inner side in the vehicle width direction; and in a sectional view, the seat frame extends upward from the air discharge ort to enter a region on the inner side in the vehicle width direction with respect to the air discharge port. With this configuration, the air discharge port is partially covered by the seat frame, so that a foreign matter is less likely to enter the air discharge port from above. The hot air is easily released through the air discharge port to the inner side in the vehicle width direction due to a sectional shape of the seat frame.

In a fourth aspect, there is provided the parts box according to any one of the first to third aspects, in which the parts holder is provided with a wall portion (46) extending in a front-rear direction on the outer side in the vehicle width direction with respect to the air discharge port. With this configuration, since the wall portion is provided at the outer side in the vehicle width direction with respect to the air discharge port, a foreign matter is less likely to enter the air discharge port from the outer side in the vehicle width direction.

In a fifth aspect, there is provided the parts box according to any one of the first to fourth aspects, in which: the parts holder is provided with a plurality of fixing portions (53b, 53c); and the plurality of fixing portions are fixed to the seat frame on a front side and on a rear side with respect to the air discharge port. With this configuration, fixing positions of the parts holder and the seat frame are provided on the front side and on the rear side of the air discharge port, and the front and rear fixing portions serve as barriers so that a foreign matter is less likely to enter the air discharge port from the front and rear.

In a sixth aspect, there is provided the parts box according to any one of the first to fifth aspects, in which an upper surface of the parts holder is further lowered on the rear side of the air discharge port, and a protruding portion (37) protrudes downward from the seat frame to enter a space defined by a lowered part of the parts holder. With this configuration, a foreign matter is less likely to enter the air discharge port from the rear due to the protruding portion of the seat frame.

In a seventh aspect, there is provided the parts box according to any one of the first to the sixth aspects, further including a battery cover (separator 61) configured to cover a battery (81) stored in the storage space is provided, in which an air intake port (58) configured to allow a driving wind to be taken into the storage space is formed by the battery cover and the vehicle body cover. With this configuration, by combining the battery cover and the vehicle body cover, the degree of freedom of the shape of the air intake port is increased, and the air intake port through which a foreign matter is less likely to enter can be formed. The hot air warmed by the heat generated by the electrical component can be pushed out by the driving wind taken in from the air intake port.

In an eighth aspect, there is provided the parts box according to the seventh aspect, in which: a pair of partition plates (64a, 64b), the pair of partition plates comprising a first partition plate and a second partition plate, protrude outward in the vehicle width direction from the battery cover; the first partition plate is located at an upper half of the battery cover and extends vertically; the second partition plate is located at a lower half of the battery cover and extends vertically; and the first partition plate and the second partition plate are spaced apart from each other in a front-rear direction to form a labyrinth structure at the air intake port. With this configuration, a foreign matter is less likely to enter the air intake port due to the labyrinth structure.

Although the present embodiment is described, a part or all of the above-described embodiment and modifications may be combined as another embodiment.

The technique according to the present disclosure is not limited to the above-described embodiment, and may be variously changed, replaced, or modified without departing from the gist of the technical concept. Further, the present disclosure may be implemented by other methods as long as the technical concept can be implemented by the methods through advance of the technique or other derivative techniques. Therefore, the claims cover all embodiments that may fall within the scope of the technical concept.

What is claimed is:

1. A parts box of a straddle-type vehicle configured to be attached to a seat frame and to store an electrical component on a lateral side of a rear fender, the parts box comprising:
a parts holder having a storage space opened on an outer side in a vehicle width direction; and
a vehicle body cover configured to cover an opening of the storage space from the outer side in the vehicle width direction,
wherein an air discharge port continuous with the storage space is formed in an upper wall of the parts holder, and
wherein the air discharge port is covered by at least one of the rear fender and the vehicle body cover at a position above the air discharge port.

2. The parts box according to claim 1,
wherein the seat frame is located at a position above the air discharge port.

3. The parts box according to claim 2,
wherein in a top view, the seat frame overlaps with a part of the air discharge port on an inner side in the vehicle width direction, and
wherein in a sectional view, the seat frame extends upward from the air discharge port to enter a region on the inner side in the vehicle width direction with respect to the air discharge port.

4. The parts box according to claim 1,
wherein the parts holder is provided with a wall portion extending in a front-rear direction on the outer side in the vehicle width direction with respect to the air discharge port.

5. The parts box according to claim 1,
wherein the parts holder is provided with a plurality of fixing portions, and
wherein the plurality of fixing portions are fixed to the seat frame on a front side and on a rear side with respect to the air discharge port.

6. The parts box according to claim 1,
wherein an upper surface of the parts holder is further lowered on the rear side of the air discharge port, and a protruding portion protrudes downward from the seat frame to enter a space defined by a lowered part of the parts holder.

7. The parts box according to claim 1, further comprising:
a battery cover configured to cover a battery stored in the storage space,
wherein an air intake port configured to allow a driving wind to be taken into the storage space is formed by the battery cover and the vehicle body cover.

8. The parts box according to claim 7,
wherein a pair of partition plates, the pair of partition plates comprising a first partition plate and a second partition plate, protrude outward in the vehicle width direction from the battery cover,
wherein the first partition plate is located at an upper half of the battery cover and extends vertically,
wherein the second partition plate is located at a lower half of the battery cover and extends vertically, and
wherein the first partition plate and the second partition plate are spaced apart from each other in a front-rear direction to form a labyrinth structure at the air intake port.
